(19) United States
(12) Patent Application Publication
(10) Pub. No.: US 2013/0052429 A1
(43) Pub. Date: Feb. 28, 2013

(54) MULTIWALL SHEET AND METHODS FOR MAKING AND USING THE SAME

(71) Applicants: Chinniah Thiagarajan, Bangalore (IN); Arun Selvaraj Kousalya, West Lafayette, IN (US); Frans Adriaansen, Bergen Op Zoom (NL)

(72) Inventors: Chinniah Thiagarajan, Bangalore (IN); Arun Selvaraj Kousalya, West Lafayette, IN (US); Frans Adriaansen, Bergen Op Zoom (NL)

(73) Assignee: SABIC INNOVATIVE PLASTICS IP B.V., Bergen op Zoom (NL)

(21) Appl. No.: 13/214,370

(22) Filed: Aug. 22, 2011

(51) Int. Cl. B32B 3/26; B32B 27/00; B32B 7/04; E04B 2/92

(52) U.S. Cl. 428/188; 29/897.32; 428/320.2; 428/223

(57) ABSTRACT

A multiwall sheet can comprise plastic walls, wherein the walls comprise a first wall; a second wall; and a transverse wall, wherein the first wall, the second wall, and the transverse wall extend longitudinally; and a rib extending between adjacent walls; and a sound insulating material disposed in an area between two adjacent walls, wherein the sound insulating material has a velocity of sound greater than the velocity of sound of the plastic walls. A method of sound insulating a structure can comprise: filling the multiwall sheet with a sound insulating material; and attaching the multiwall sheet to the structure.

Disclosed herein are multiwall sheets, and more particularly sound insulated multiwall sheets, e.g., for use in glazing and industrial applications.

### BACKGROUND

In the construction of naturally lit structures (e.g., greenhouses, pool enclosures, conservatories, stadiums, sunrooms, and so forth), glass has been employed in many applications as transparent structural elements, such as, windows, facings, and roofs. However, polymer sheeting is replacing glass in many applications due to several notable benefits.

One benefit of polymer sheeting is that it exhibits excellent impact resistance compared to glass. This in turn reduces breakage and hence, maintenance costs in applications wherein vandalism, hail, contraction/expansion, and so forth, is encountered. Another benefit of polymer sheeting is a significant reduction in weight compared to glass. This makes polymer sheeting easier to install than glass and reduces the load-bearing requirements of the structure on which they are installed.

In addition to these benefits, one of the most significant advantages of polymer sheeting is that it provides improved insulative properties compared to glass. This characteristic significantly affects the overall market acceptance of polymer sheeting as consumers desire structural elements with improved efficiency to reduce heating and/or cooling costs. Although the insulative properties of polymer sheeting are greater than that of glass, it is challenging to have a low thermal insulation value, high stiffness (i.e., rigidity), and light transmission in polymer sheeting. Thus, there is a continuous demand for further improvement.

Multiwall sheets are commonly designed for structural and thermal insulation applications. As mentioned, higher thermal insulation values are continually sought in the industry for multiwall sheet applications. Sound pollution is another concern with effective materials for cost effective sound insulation being needed. Increasing the weight of the multiwall sheet is a possibility for increasing sound insulation. However, such an increase in weight is counterproductive to the weight savings utilized by using polymer sheeting compared to glass and adds to the overall cost of the sheeting. Additionally, for applications in which a transparent multiwall sheet is desired, it can be difficult to achieve the desired sound insulation properties of the multiwall sheet without also compromising the transparency of the multiwall sheet.

Thus, there is a need for multiwall sheets that possess increased sound insulation without a significant increase in weight. There is also a need for increased sound insulation properties without minimal or no impact on the overall transparency of the multiwall sheet. Additionally, multiwall sheets that can be produced with increased sound insulation properties without an increase in manufacturing steps and thus cost, are also desired.

### SUMMARY

Disclosed, in various embodiments, are multiwall sheets and methods for making and using the same.

In an embodiment, a multiwall sheet comprises: plastic walls, wherein the walls comprise a first wall; a second wall; and a transverse wall, wherein the first wall, the second wall, and the transverse wall extend longitudinally; a rib extending between adjacent walls; and a sound insulating material disposed in an area between two adjacent walls; wherein the sound insulating material has a velocity of sound greater than the velocity of sound of the plastic walls.

In another embodiment, a multiwall sheet comprises: plastic walls, wherein the walls comprise a first wall; a second wall; and a transverse wall, wherein the first wall, the second wall, and the transverse wall extend longitudinally; a rib extending between adjacent walls; and a sound insulating material disposed in an area between two adjacent walls; wherein the sound insulating material has an acoustic impedance of greater than or equal to 5 MRayl.

In another embodiment, a multiwall sheet comprises: polycarbonate walls, wherein the walls comprise: a first wall; a second wall; and a transverse wall, wherein the first wall, the second wall, and the transverse wall extend longitudinally; a rib extending between adjacent walls; and a sound insulating material disposed in an area between two adjacent walls; wherein the sound insulating material comprises silica and wherein the sound insulating material has a velocity of sound of greater than or equal to 4,000 m/s and an acoustic impedance of greater than or equal to 10 MRayl.

In one embodiment, a method of making a sound insulating structure comprises: filling a multiwall sheet with a sound insulating material, wherein the multiwall sheet comprises: plastic walls, wherein the walls comprise: a first wall; a second wall; and a transverse wall, wherein the first wall, the second wall, and the transverse wall extend longitudinally; and a rib extending between adjacent walls; wherein the sound insulating material is disposed in an area between two adjacent walls and has a velocity of sound of greater than the velocity of sound of the plastic wall; and attaching the multiwall sheet to the structure.

In another embodiment, a method of making a multiwall sheet comprises: forming a multiwall sheet, wherein the multiwall sheet comprises plastic walls, wherein the plastic walls comprise: a first wall; a second wall; and a transverse wall, wherein the first wall, the second wall, and the transverse wall extend longitudinally; and a rib extending between adjacent walls; filling an area between two adjacent walls with a sound insulating material having a velocity of sound greater than the velocity of sound of the plastic walls.

These and other features and characteristics are more particularly described below.

### BRIEF DESCRIPTION OF THE DRAWINGS

The following is a brief description of the drawings wherein like elements are numbered alike and which are presented for the purposes of illustrating the exemplary embodiments disclosed herein and not for the purposes of limiting the same.

FIG. 1 is a partial, cross-sectional view of a multiwall sheet with areas filled with a sound insulating material.

FIG. 2 is a partial, cross-sectional view of a multiwall sheet having an element disposed in some areas and a sound insulating material in other areas.

FIG. 3 is a partial, cross-sectional view of a two wall multiwall sheet.

FIG. 4 is a partial, cross-sectional view of an eleven wall multiwall sheet.

FIG. 5 is a partial, cross-sectional view of a nine wall multiwall sheet.

FIG. 6 is a partial, cross-sectional view of a multiwall sheet with cavities partly filled with a sound insulating material.

FIG. 7 is a graphical representation of the sound transmission loss versus the frequency of a three wall multiwall sheet.

FIG. 8 is a graphical representation of the sound transmission loss versus the frequency of a two wall multiwall sheet.

FIG. 9 is a perspective view of an exemplary embodiment of a naturally lit structure utilizing a multiwall sheet as disclosed herein.

### DETAILED DESCRIPTION

Disclosed herein are multiwall sheets and methods of making in which various areas and/or various cavities of the multiwall sheets are filled with a sound insulating material. The sound insulating material can have a velocity of sound greater than the velocity of sound of the material of the multiwall sheet. Alternatively, or in addition to the higher velocity of sound, the sound insulating material can have an acoustic impedance of greater than or equal to 5 megaRayleighs (MRayl) where 1 Rayleigh is equivalent to 1 kg/m²s.

Multiwall sheets having an area filled with this sound insulating material display a surprisingly higher sound transmission loss as compared to non-filled sheets (i.e., filled with air). Generally, a one or two decibel (dB) increase in the sound transmission loss is considered a significant improvement. The multiwall sheets disclosed herein can provide a greater than or equal to 15 dB increase in the sound transmission loss, specifically, greater than or equal to 20 dB increase in the sound transmission loss.

Sound reduction can be achieved either by sound transmission loss or by sound absorption. Not to be limited by theory, sound absorption generally operates by interacting with the incident sound waves and is mainly a surface interaction phenomenon. Sound is not absorbed effectively with materials such as fiberglass, cellulose, foam, and mineral wool. However, when sound transmission loss materials as herein described are used to achieve sound reduction in multiwall sheets, there is an effective reduction in sound.

Filling an area of the multiwall sheet as described herein generally refers to packing a sound insulating material into the space between two adjacent walls of the multiwall sheet. For example, an area can be packed with greater than or equal to 50 volume percent (vol. %) of the sound insulating material, specifically, greater than or equal to 75 vol. % packed with the sound insulating material, more specifically, greater than or equal to 85 vol. % packed with the sound insulating material, even more specifically, greater than or equal to 95 vol. % packed with the sound insulating material, still more specifically, greater than or equal to 99 vol. % packed with the sound insulating material, and even yet more specifically, 100 vol. % packed with the sound insulating material. With the presence of the sound insulating material, the improvement in sound transmission loss can be greater than or equal to 500% compared to a multiwall sheet having the same material composition and structure but with, e.g., air in the areas. Sound pollution is a key concern in certain applications and thus, multiwall sheets with improved sound transmission losses are needed for sound insulation.

Sound insulation, or alternatively, sound transmission loss (STL) is a function of the mass and thickness of a sheet. Unless specifically stated otherwise, as used herein, sound transmission loss is calculated based upon the Sound Transmission Class according to ASTM E413 and the Sound Reduction Index according to ISO 717-DIN 52210, which employ different frequency ranges. The multiwall sheets disclosed herein offer at least a greater than or equal to 100% improvement in the specific STL value for a given sheet and even up to a 500% improvement in the specific STL value for a given sheet, compared to a multiwall sheet having the same material composition and structure but without the sound insulating material, where the specific STL value is measured based upon the sound transmission performance for a square meter area of a sheet for a given weight of the sheet where the weight of the sheet is measured in kilograms per square meter (kg/m²).

Generally, STL is a function of mass and acoustic damping. The multiwall sheets disclosed herein offer a system which provides efficient damping and sound insulation. The multiwall sheets disclosed herein can have a higher structural performance index as compared to an equivalent thickness solid sheet and, when the multiwall sheet is filled with a sound insulating material (e.g., a granular material) can also provide greater sound insulating capabilities as compared to a non-filled multiwall sheet (i.e., filled with air). It is believed that the sound insulating material resonates and dissipates the sound energy within the multiwall sheet thereby providing an exceptional sound transmission loss as specified by ASTM E413. Without wishing to be bound by theory, the sound insulating material can resonate and dissipate the sound energy because it has a longitudinal velocity of sound that is greater than the longitudinal velocity of sound of the material of the multiwall sheet. For example, the sound insulating material can have a longitudinal velocity of sound of greater than or equal to 4,000 meters per second (m/s), specifically, greater than or equal to 5,000 m/s.

It is also believed that the sound insulating material can resonate and dissipate sound energy because it has an acoustic impedance of greater than or equal to 5 MRayl, specifically, greater than or equal to 10 MRayl, more specifically, greater than or equal to 25 MRayl, and still more specifically, greater than or equal to 35 MRayl. Acoustic impedance is the ratio of acoustic pressure to flow. Acoustic impedance is calculated from the following Equation (1):

Z=ρ*V (1)

wherein
Z=acoustic impedance
ρ=density
V=velocity.

Polycarbonate, a material that can be used to make the multiwall sheet, generally has a longitudinal velocity of sound of 2,300 m/s, a shear wave sound velocity value of 1,250 m/s, and an acoustic impedance value of 2.75 MRayl. Air has a longitudinal velocity of sound of 334 m/s. Thermoplastic resins generally have a longitudinal velocity of sound of 1,600 m/s to 2,800 m/s; a shear wave sound velocity of 500 m/s to 1,600 m/s; and an acoustic impedance value of 1.5 MRayl to 3 MRayl. Liquids generally have a longitudinal velocity of sound of 750 m/s to 1,500 m/s and an acoustic impedance of 0.8 MRayl to 1.5 MRayl.

The multiwall sheet can be formed from a plastic material, such as thermoplastic resins, thermosets, and combinations comprising at least one of the foregoing. Possible thermoplastic resins that may be employed to form the multiwall sheet include, but are not limited to, oligomers, polymers, ionomers, dendrimers, copolymers such as graft copolymers, block copolymers (e.g., star block copolymers, random copolymers, etc.) and combinations comprising at least one of the foregoing. Examples of such thermoplastic resins include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (e.g., polyetherimides), acrylonitrile-styrene-butadiene (ABS), polyalkylmethacrylates (e.g., polymethylmethacrylates), polyesters (e.g., copolyesters, polythioesters), polyolefins (e.g., polypropylenes and polyethylenes, high density polyethylenes, low density polyethylenes, linear low density polyethylenes), polyamides (e.g., polyamideimides), polyarylates, polysulfones (e.g., polyarylsulfones, polysulfonamides), polyphenylene sulfides, polytetrafluoroethylenes, polyethers (e.g., polyether ketones, polyether etherketones, polyethersulfones), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazzanes, polysiloxanes, and combinations comprising at least one of the foregoing.

More particularly, the plastic used in the multiwall sheet can include, but is not limited to, polycarbonate resins (e.g., Lexan* resins, commercially available from SABIC Innovative Plastics), polyphenylene ether-polystyrene resins (e.g., Noryl* resins, commercially available from SABIC Innovative Plastics), polyetherimide resins (e.g., Ultem* resins, commercially available from SABIC Innovative Plastics), polybutylene terephthalate-polycarbonate resins (e.g., Xenoy* resins, commercially available from SABIC Innovative Plastics), copolyestercarbonate resins (e.g. Lexan* SLX resins, commercially available from SABIC Innovative Plastics), and combinations comprising at least one of the foregoing resins. Even more particularly, the thermoplastic resins can include, but are not limited to, homopolymers and copolymers of a polycarbonate, a polyester, a polyacrylate, a polyamide, a polyetherimide, a polyphenylene ether, or a combination comprising at least one of the foregoing resins. The polycarbonate can comprise copolymers of polycarbonate (e.g., polycarbonate-polysiloxane, such as polycarbonate-polysiloxane block copolymer), linear polycarbonate, branched polycarbonate, end-capped polycarbonate (e.g., nitrile end-capped polycarbonate), and combinations comprising at least one of the foregoing, for example, a combination of branched and linear polycarbonate.

The multiwall sheet can include various additives ordinarily incorporated into polymer compositions of this type, with the proviso that the additive(s) are selected so as to not significantly adversely affect the desired properties of the sheet, in particular, sound transmission loss and desired degree of transparency. Such additives can be mixed at a suitable time during the mixing of the components for forming the multiwall sheet. Exemplary additives include impact modifiers, fillers, reinforcing agents, antioxidants, heat stabilizers, light stabilizers, ultraviolet (UV) light stabilizers, plasticizers, lubricants, mold release agents, antistatic agents, colorants (such as carbon black and organic dyes), surface effect additives, radiation stabilizers (e.g., infrared absorbing), flame retardants, diffusion barriers (e.g., gas and/or liquid barriers), and anti-drip agents. A combination of additives can be used, for example a combination of a heat stabilizer, mold release agent, and ultraviolet light stabilizer. In general, the additives are used in the amounts generally known to be effective for providing the desired property (e.g., UV light stabilizers are effective for filtering UV and protecting the multiwall sheet from UV light). The total amount of additives (other than any impact modifier, filler, or reinforcing agents) is generally 0.001 wt % to 5 wt %, based on the total weight of the composition of the multiwall sheet.

In addition to sound transmission, the plastic material can be chosen to exhibit sufficient impact resistance such that the sheet is capable of resisting breakage (e.g., cracking, fracture, and the like) caused by impact (e.g., hail, birds, stones and so forth). Therefore, plastics exhibiting an impact strength greater than or equal to about 7.5 foot-pounds per square inch (ft-lb/in²) (4.00 Joules per square centimeter (J/cm²)), or more specifically, greater than about 10.0 ft-lb/in² (5.34 J/cm²) or even more specifically, greater than or equal to about 12.5 ft-lb/in² (6.67 J/cm²) are desirable, as tested per ASTM D-256-93 (Izod Notched Impact Test). Further, desirably, the plastic has ample stiffness to allow for the production of a sheet that can be employed in applications wherein the sheet is generally supported and/or clamped on two or more sides of the sheet (e.g., clamped on all four sides), such as in greenhouse applications comprising tubular steel frame construction. Sufficient stiffness herein is defined as polymers comprising a Young's modulus (e.g., modulus of elasticity) that is greater than or equal to about 1×10⁹ Newtons per square meter (N/m²), more specifically 1×10⁹ to 20×10⁹ N/m², and still more specifically 2×10⁹ to 10×10⁹ N/m².

The sound insulating material used in the multiwall sheet can be any material that will provide the desired sound insulating properties, e.g., has a velocity of sound greater than the velocity of sound of the material of the multiwall sheet and/or has an acoustic impedance of greater than or equal to 5 MRayl. For example, the sound insulating material can comprise a solid material (e.g., a granular material). The sound insulating material can comprise materials such as silica (e.g., sand), concrete, copper, alumina, glass, granite, iron, sodium chloride (e.g., salt, NaCl), zinc oxide, tungsten, ceramic (e.g., ceramic granules), as well as combinations comprising at least one of the sound insulating materials. In an embodiment, the sound insulating material comprises silica (SiO₂) having a particle size ranging from 0.075 to about 10 millimeters (mm), with a mean particle size of 0.5 to 2 mm Acoustic properties of various sound insulating materials are listed in Table 1.

TABLE 1
Acoustic Properties of Sound Insulating Materials

| | Longitudinal | Shear Wave | Acoustic |
|---|---|---|---|
| | Velocity | Velocity of | Impedance |
| Material | of Sound (m/s) | Sound (m/s) | (MRayl) |
| Silica | 5,968 | 4,379 | 8.65 |
| Concrete | 3,100 | 2,100 | 8.00 |
| Copper | 5,010 | 2,270 | 44.60 |
| Alumina | 10,520 | 4,000 | 40.60 |
| Glass | 5,100 | 3,280 | 14.09 |
| Granite | 6,500 | 2,700 | 17.60 |
| Iron | 5,900 | 3,200 | 46.40 |
| Sodium Chloride | 4,780 | 3,150 | 10.39 |
| Zinc Oxide | 6,400 | 2,950 | 36.40 |
| Tungsten | 5,200 | 2,000 | 101.00 |

The sound insulating material can be transparent (e.g., can have a light transmission of greater than or equal to 85%), or can be opaque, or can be translucent (e.g., can have a light transmission of 1% to 84%, specifically, 50% to 75%). The sound insulating material can also provide additional optical, and/or thermal, and/or structural performance. For example, the sound insulating material can improve the thermal properties of the multiwall sheet if the sound insulating material is also a superinsulating material that can provide increased thermal insulation to the multiwall sheet.

Before the sound insulating material is introduced to the multiwall sheet, the sheet is generally transparent (e.g., the multiwall sheet generally has greater than or equal to 95% light transmission). After the sound insulating material is introduced, the transparency of the sheet generally decreases. For example, before introduction of the sound insulating material, the sheet can have a transparency of greater than or equal to 85%, specifically, greater than or equal to 90%, more specifically, greater than or equal to 95%, even more specifically, greater than or equal to 96%, and still more specifically, greater than or equal to 99%.

Percent transmission for laboratory scale samples can be determined using ASTM D1003-00, procedure B using CIE standard illuminant C. ASTM D-1003-00 (Procedure B, Spectrophotometer, using illuminant C with diffuse illumination with unidirectional viewing) defines transmittance as:

$$\% T = ( \frac{I}{{I}_{O}} ) \times 100 \% \qquad ( 2 )$$

wherein: I=intensity of the light passing through the test sample
Iₒ=Intensity of incident light.

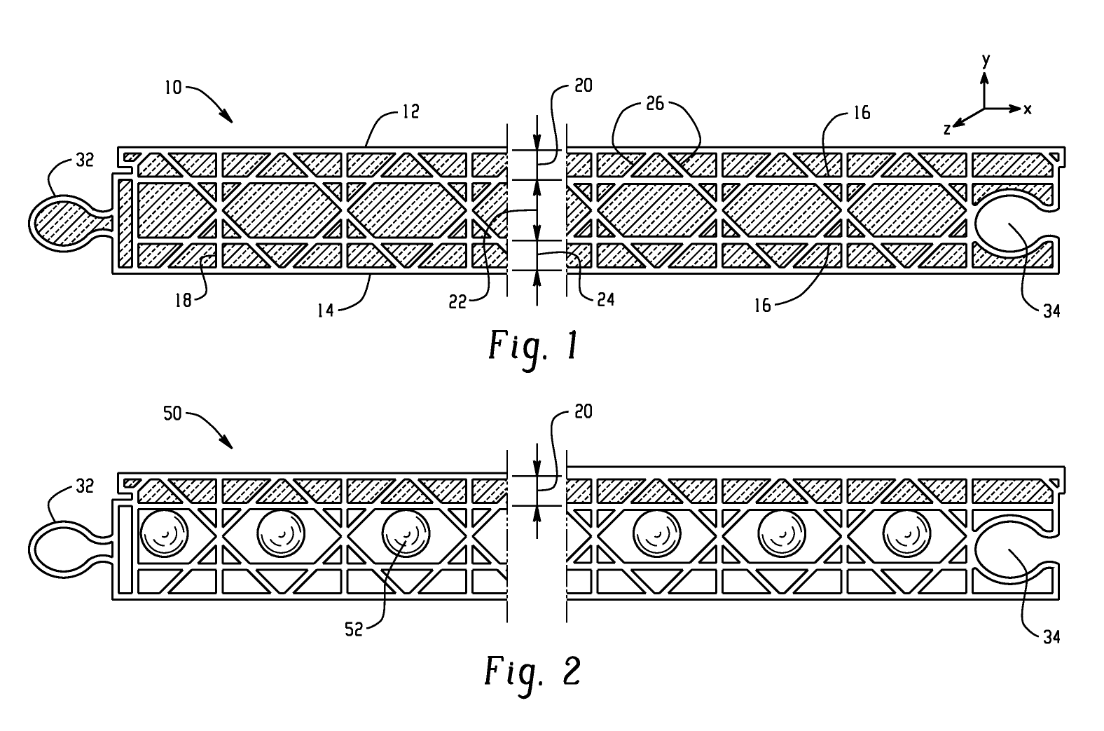

A multiwall sheet can be formed from various polymer processing methods, such as extrusion or injection molding, if produced as a unitary structure. Continuous production methods, such as extrusion, generally offer improved operating efficiencies and greater production rates than non-continuous operations, such as injection molding. Specifically, a single screw extruder can be employed to extrude a polymer melt (e.g., polycarbonate, such as Lexan*, commercially available from SABIC Innovative Plastics). The polymer melt is fed to a profile die capable of forming an extrudate having the cross-section of the multiwall sheet 10 illustrated in FIG. 1. The multiwall sheet 10 travels through a sizing apparatus (e.g., vacuum bath comprising sizing dies) and is then cooled below its glass transition temperature (e.g., for polycarbonate, about 297° F. (147° C.)).

After the panel has cooled, it can be cut to the desired length utilizing an extrusion cutter, such as an indexing in-line saw. Once cut, the multiwall sheet can be subjected to secondary operations before packaging. Exemplary secondary operations can comprise annealing, printing, attachment of fastening members, trimming, further assembly operations, and/or any other desirable processes. The size of the extruder, as measured by the diameter of the extruder's screw, is based upon the production rate desired and calculated from the volumetric production rate of the extruder and the cross-sectional area of the panel. The cooling apparatus can be sized (e.g., length) to remove heat from the extrudate in an expedious manner without imparting haze.

Haze can be imparted when a polymer (e.g., polycarbonate) is cooled rapidly. Therefore, the cooling apparatus can operate at warmer temperatures (e.g., greater than or equal to about 100° F. (39° C.), or more specifically, greater than or equal to 125° F. (52° C.), rather than colder temperatures (e.g., less than 100° F. (39° C.), or more specifically, less than or equal to about 75° F. (24° C.)) to reduce hazing. If warmer temperatures are employed, the bath length can be increased to allow ample time to reduce the extrudate's temperature below its glass transition temperature. The size of the extruder, cooling capacity of the cooling apparatus, and cutting operation can be capable of producing the multiwall sheet 10 (FIG. 1) at a rate of greater than or equal to about 5 feet per minute. However, production rates of greater than about 10 feet per minute, or even greater than about 15 feet per minute can be achieved if such rates are capable of producing surface features that comprise the desired attributes.

Co-extrusion methods can also be employed for the production of the multiwall sheet. Co-extrusion can be employed to supply different polymers to any portion of the multiwall sheet's geometry to improve and/or alter the performance of the sheet and/or to reduce raw material costs. One skilled in the art would readily understand the versatility of the process and the myriad of applications in which co-extrusion can be employed in the production of multiwall sheets.

The multiwall sheet can be filled with the sound insulating material before being installed on a structure, but after being formed and delivered to the site where it will be attached to a structure or can be filled with the sound insulating material after installation on a structure (e.g., a building, frame, roof, enclosure, etc.) so that the multiwall sheet can be tailored to meet the specific needs of its end use application. In one embodiment, a method of sound insulating a structure can comprise filling a multiwall sheet as described herein and attaching the multiwall sheet to the structure. The multiwall sheet can be filled with the sound insulating material by determining a degree of sound insulation desired in an area of the structure and then filling the multiwall sheet based upon the result obtained.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

FIG. 1 illustrates a multiwall sheet 10 comprising walls, where the walls include a first wall 12, a second wall 14, a transverse wall 16, and a rib 18 extending between the first wall 12 and the second wall 14, the first wall 12 and the transverse wall 16, and/or the transverse wall 16 and the second wall 14. In other words, the rib 18 can extend between and contact any two adjacent walls. The first wall 12 and the second wall 14 are the outermost walls of the multiwall sheet 10. In one embodiment, the transverse wall 16 can extend longitudinally the length of the first wall 12 and the second wall 14 (e.g., extend between first wall 12 and second wall 14, but not contact). In another embodiment, the transverse wall 16 can be parallel to the first wall 12 and the second wall 14 or, the transverse wall 16 can be substantially parallel to the first wall 12 and the second wall 14 (e.g., not completely parallel across the entire length of the first wall 12 and the second wall 14, but also not intersecting the first wall 12 or the second wall 14, accommodating for slight variations in the orientation during processing). Areas 20, 22, and 24 are formed by the open spaces located between adjacent walls, e.g., area 20 is formed by the first wall 12 and a transverse wall 16, area 22 is formed by two adjacent transverse walls 16, and area 24 is formed by transverse wall 16 and second wall 14. Also located in the open spaces are, optionally, dividers 26, which are non-parallel and non-perpendicular to the walls and the rib 18.

The multiwall sheet 10 illustrated in FIG. 1 can be filled with a sound insulating material as previously described to increase the STL performance of the multiwall sheet 10. Any combination of areas can be filled with the sound insulating material. For example, area 20 can be filled with a sound insulating material, specifically, area 22, more specifically, area 24, even more specifically, area 20 and area 22, still more specifically, area 22 and area 24, yet more specifically area 20 and area 24, and yet more specifically still, area 20, area 22, and area 24. In the embodiment illustrated in FIG. 1, areas 20, 22, and 24 are filled with a sound insulating material. FIG. 2 illustrates a multiwall sheet 50 with area 20 filled with a sound insulating material. Disposed within area 22 can be an element 52. Element 52 can, for example, be used for displays, signs, entertainment purposes, architectural purposes, aesthetic features, and so forth. Element 52 can be a light guide, a light emitting diode (LED), a fiber optic, a motion sensor, a phosphorescent filler (e.g., for decorative purposes), an infrared (IR) absorber, a reflective filler, and so forth, as well as combinations comprising at least one of the foregoing. Optionally, as illustrated in FIGS. 1 and 2, the multiwall sheet 10, 50 can additionally include a clip 32 located at an end of the multiwall sheet to facilitate attachment to a structure, frame enclosure for the multiwall sheet, or to another multiwall sheet. Also as illustrated in FIGS. 1 and 2, the multiwall sheet can, optionally, include a receiving end 34 for a clip to attach thereto.

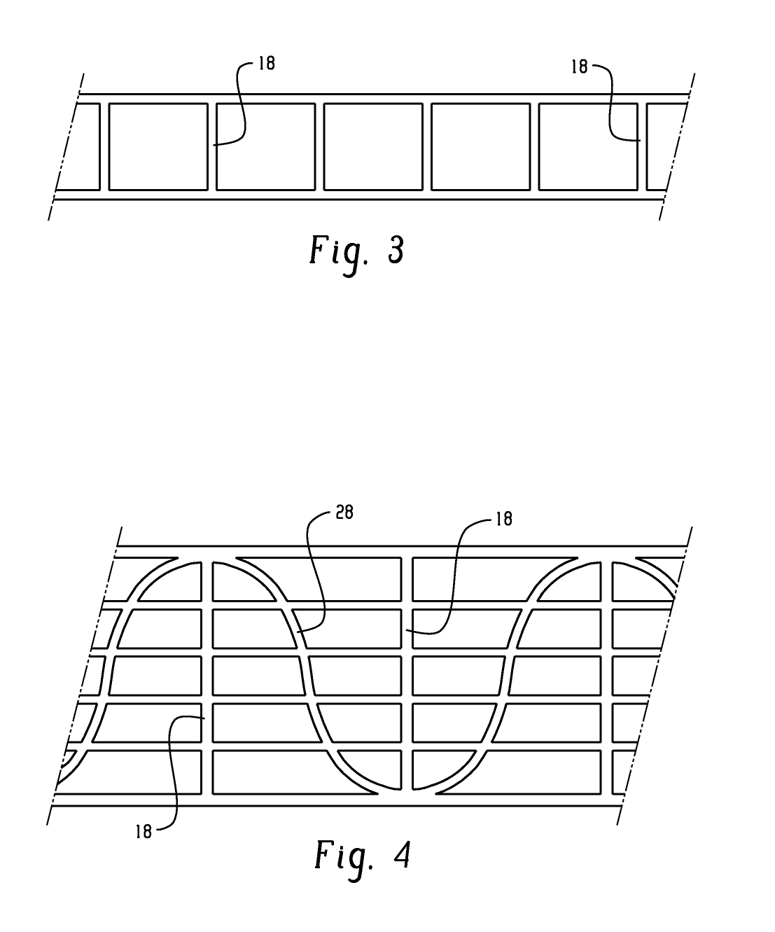

FIGS. 3, 4, and 5 illustrate further embodiments of multiwall sheets. For example, FIG. 4 illustrates a multiwall sheet having sinusoidal shaped dividers 28. It is contemplated that any shape dividers could be used. For example, the dividers can comprise a shape such as lamellar-shaped elements, triangular-shaped elements, pyramidal-shaped elements, cylindrical-shaped elements, conical-shaped elements, cubical-shaped elements, trapezoidal-shaped elements, sinusoidal-shaped elements, saw tooth-shaped elements, abs(sin)-shaped elements, cycloid-shaped elements, fiber shaped elements and combinations comprising at least one of the foregoing.

FIG. 6 illustrates a multiwall sheet 60 where each cavity 30 is partially filled with a sound insulating material. In one embodiment, each cavity 30 between adjacent ribs 18 dispersed across the length “l” (see FIG. 1) of the multiwall sheet 10 is filled with the sound insulating material. Cavity 30 as described herein refers to the area formed by a zone between two adjacent ribs in the area 20, 22, 24. In other embodiments, some cavities 30 are filled with the sound insulating material, while others are not filled (e.g., filled with air). For example, every other cavity 30 can be filled with the sound insulating material or two adjacent cavities 30 can be filled with the sound insulating material with empty cavities (e.g., filled with air) on either side of the filled cavities 30.

Different visual effects can be created by using colored sound insulating material (e.g., colored granular material). For example, a color can be used to fill one cavity 30 and a different color used to fill another cavity 30, creating different visual effects. In this embodiment, some of the sheet can be transparent (e.g., at least 85% transparent), while the areas filled with the sound insulating material can be opaque or translucent. Each cavity 30 can also be partly or completely filled with a sound insulating material. FIG. 1 illustrates an embodiment where each cavity is completely filled with the sound insulating material, while FIG. 6 illustrates an embodiment where each cavity 30 is partly filled with the sound insulating material. For example, the cavity 30 can be greater than or equal to 30 vol. % filled with the sound insulating material, specifically, 40 vol. % filled, more specifically, 50 vol. % filled, even more specifically, 60 vol. % filled, still more specifically 75 vol. % filled, yet more specifically, 90 vol. % filled, even more specifically still, 95 vol. % filled, yet more specifically still, 99 vol. % filled, and even yet more specifically still, 100 vol. % filled.

The multiwall sheet can be tuned such that specific areas of the multiwall sheet can be more sound insulating than others. For example, some cavities can be filled with the sound insulating material to provide sound insulation over the area covered by the multiwall sheet, while other cavities of the multiwall sheet can be left unfilled or only partly filled if sound insulation is not desired or needed in certain areas of the multiwall sheet. By tuning the sound insulation, the desired sound reduction can be attained while minimizing the weight increase.

The total thickness (t) (see FIG. 1, where t is illustrated along the Z axis) of the multiwall sheet is generally less than or equal to 100 millimeters (mm), more specifically, less than or equal to 55 mm, still more specifically, less than or equal to 32 mm, but generally greater than or equal to 6 mm. In one embodiment, the multiwall sheet has a thickness of 16 mm. In one another embodiment, the multiwall sheet has a thickness of 10 mm.

The multiwall sheet can comprise a width (w) (see FIG. 1, where w is illustrated along the Y axis) capable of providing sufficient spatial area coverage for the intended use (e.g., as a roofing, sheeting, or similar products). For example, the width of the multiwall sheet can generally be less than or equal to 2 meters (m), more specifically, less than or equal to 1.8 m, still more specifically, less than or equal to 1.25 m, but generally greater than or equal to 400 mm. In one embodiment, the multiwall sheet has a width of 1 m.

The multiwall sheet can comprise a length (l) (see FIG. 1, where/is illustrated along the X axis) capable of providing sufficient stiffness for the intended use (e.g., as a roofing, sheeting product, or similar product). For example, the length of the multiwall sheet can generally be greater than or equal to 100 mm, more specifically, greater than or equal to 1 m, still more specifically, greater than or equal to 1.5 m, but generally greater than or equal to 6 m. When assembled, the multiwall sheet can be exposed to a variety of forces caused by snow, wind, rain, hail, and the like. The sheet is desirably capable of withstanding these forces without failing (e.g., buckling, cracking, bowing, and so forth). The specific dimensions of the multiwall sheet can be chosen so that the multiwall sheet can withstand these forces.

STL can be predicted using numerical prediction of acoustic performance of multiwall sheet using prediction software, e.g., COMSOL Multiphysics software. Sound transmission class can be calculated according to ASTM E413, while the sound reduction index (R_{w}) can be calculated according to ISO 717-DIN 52210. These standards are generally used to rate partitions, doors, windows, and roofs for their effectiveness in blocking sound.

The following examples are merely illustrative of the device disclosed herein and are not intended to limit the scope hereof. All of the following examples were based upon simulations unless specifically stated otherwise.

### EXAMPLES

### Example 1

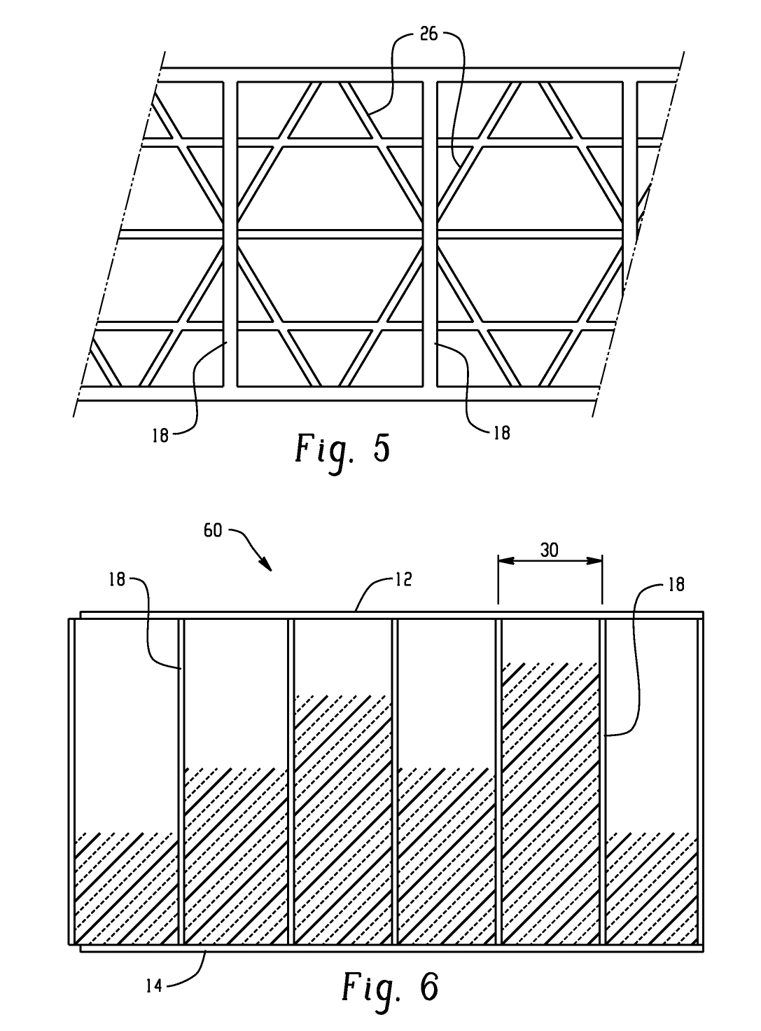

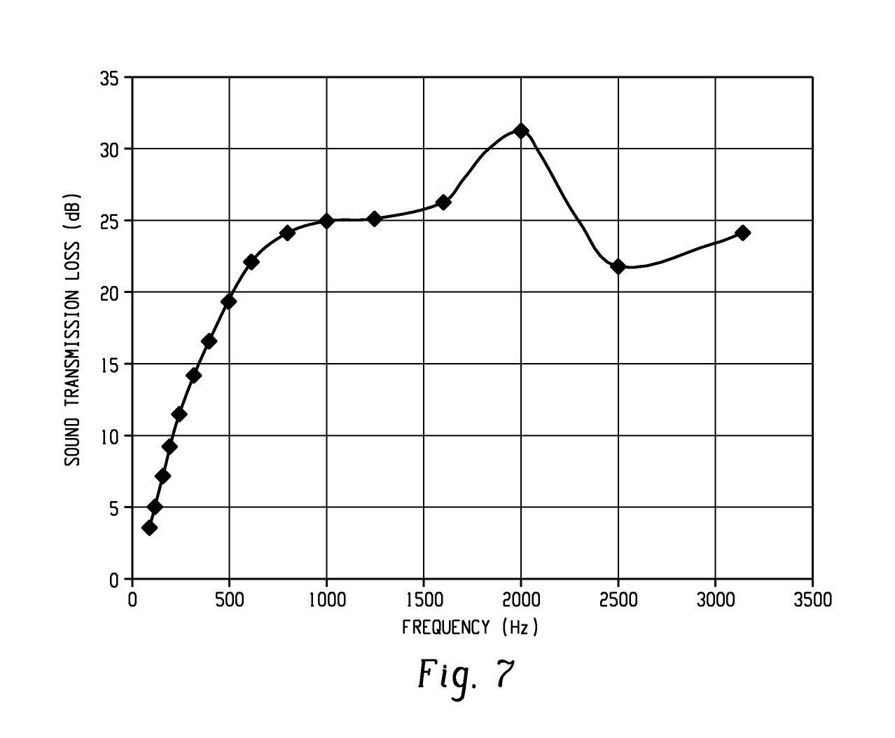

In this example, numerical simulation software is used to predict the STL of a multiwall sheet filled with a sound insulating material. The multiwall sheet in this Example is a 3 wall, 16 mm thick multiwall sheet with a 16 mm distance between adjacent ribs. The cross section is similar to that shown in FIG. 5, except that the multiwall sheet in FIG. 5 has a thickness of 32 mm and has 6 walls. FIG. 7 illustrates a plot of the STL prediction using the COMSOL Multiphysics software compared to the frequency. In FIG. 7, an STL numerically predicted value is shown compared to an STL value predicted experimentally for the sheet. In this example, granular material is used as the sound insulating material. The granular material is silica (SiO₂), has a density of 1,450 grams per cubic meter (g/m³), and a velocity of sound of 5,968 meters per second (m/s). The polycarbonate has a velocity of sound of 2,270 m/s, almost three times less that of the sound insulating material. The granular material is modeled as an effective fluid with the pressure acoustics module in the COMSOL Multiphysics software. The addition of silica to the areas of the multiwall sheet results in an unexpectedly large increase in the STL of the multiwall sheet. The almost three times difference in the velocity of sound between the two materials allows for greater sound insulation because of the larger velocity of sound the granular material, which absorbs sound waves more readily than the polycarbonate. In FIG. 7, the numerically predicted STL value is 22 dB, while the experimentally measured STL value is 21 dB, illustrating that the numerical prediction is within plus or minus 1 dB of the experimental prediction.

### Example 2

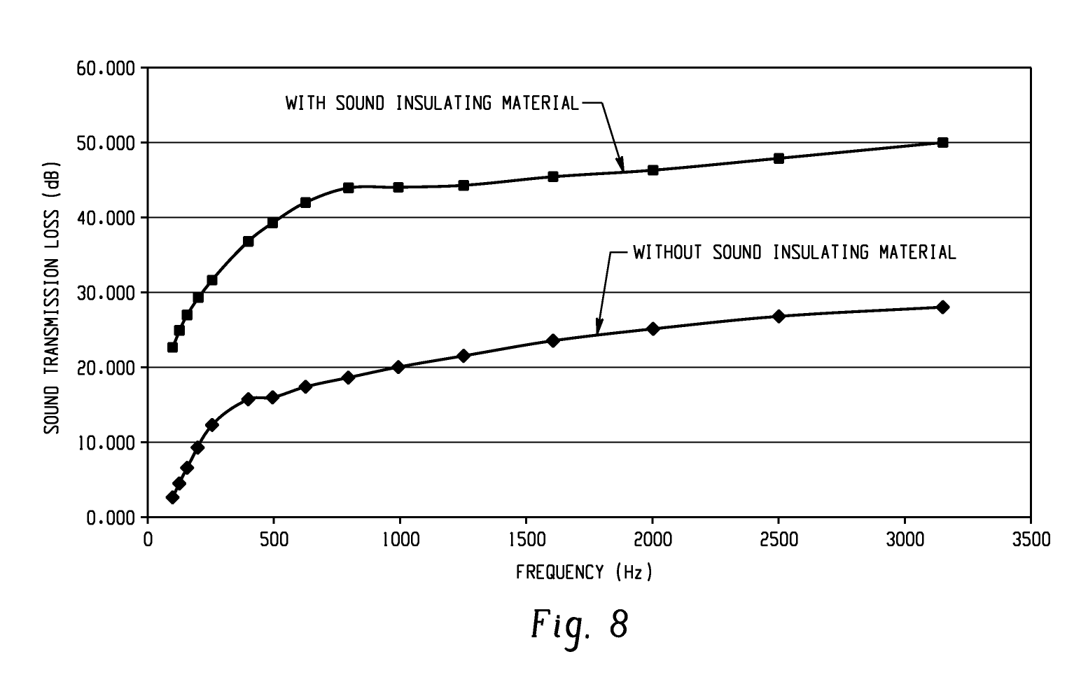

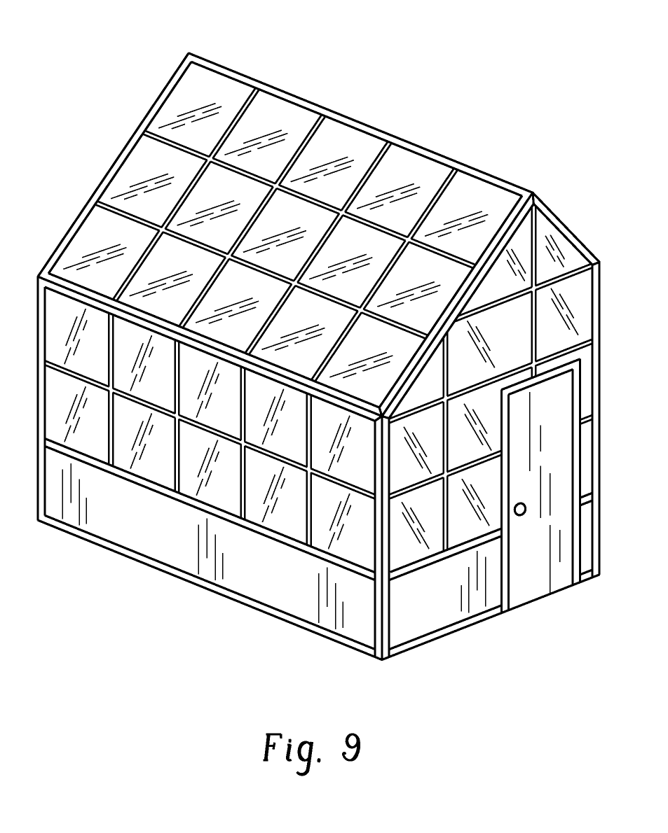

FIG. 8 illustrates a comparison of the STL versus the frequency of a polycarbonate multiwall sheet with and without a sound insulating material. The multiwall sheets in FIG. 8 are 10 mm thick with a 10 mm distance between adjacent ribs and have 2 walls. The sheets are 100 vol. % filled with silica as described above with respect to example 1 as the granular material (e.g., all the areas between adjacent ribs are filled with the granular material). The sheet is initially transparent (i.e., greater than or equal to 86% transparent) and after filling with the granular material, the transparency of the multiwall sheet decreases to 80%. The cross-section of the multiwall sheet in this example corresponds to that illustrated in FIG. 3. In FIG. 8, it can be seen that the STL is greater for the multiwall sheet with the granular material as compared to the same multiwall sheet without the granular material. For example, it can be seen that the STL for the multiwall sheet without the granular material is 20 dB, while the STL for the same multiwall sheet with the granular material is about 42 dB, a significant increase in the STL.

The STL for a 10 mm thick, solid polycarbonate sheet is 33 dB, while that for a 10 mm thick, solid sheet of steel is 37 dB across the entire audible frequency spectrum. Example 2 illustrates that with a 10 mm thick polycarbonate multiwall sheet with granular material, the STL can be increased to 42 dB as compared to a 10 mm thick polycarbonate sheet without granular material which has a STL value of 20 dB. Hence, at a suitable reduced weight compared to a solid sheet of steel, the filled plastic sheet has better STL.

### Example 3

Table 2 illustrates the STL and specific STL values for various multiwall sheets. Specific STL is a measure of sound transmission performance for a square meter area for a given weight of the material. As can be seen in Table 2, the multiwall sheet having a sound insulating material shows a significant improvement in the STL value and the specific STL value as compared to the same multiwall sheet but with no sound insulating material, as compared to a solid polycarbonate (PC) sheet with the same thickness, and as compared to a steel sheet. The % Improvement of the specific STL of Sample 1 compared to Samples 2, 3, and 4 is calculated by subtracting the specific STL of e.g., Sample 2 from the specific STL of Sample 1, dividing the result by the specific STL of Sample 2, and multiplying that result by 100.

TABLE 2

| | | | | Specific STL | % Improvement |
|---|---|---|---|---|---|
| | | STL | Weight | (STL/weight) | of Specific STL |
| Sample # | Sheet Type | (dB) | (kg/m²) | (dB-m²/kg) | of Sample 1 |
| 1 | 10 mm thick, 2 wall PC | 42 | 1.7 | 24.71 | |
| | sheet, 10 mm distance | | | | |
| | between adjacent ribs, filled | | | | |
| | with SiO₂ | | | | |
| 2 | 10 mm thick, 2 wall PC | 20 | 1.7 | 11.76 | 110 |
| | sheet, 10 mm distance | | | | |
| | between adjacent ribs, filled | | | | |
| | with air | | | | |
| 3 | 10 mm thick, solid PC sheet | 33 | 12 | 2.75 | 798 |
| 4 | 10 mm thick, solid steel | 37 | 78 | 0.47 | 5,157 |
| | sheet | | | | |

As illustrated in Table 2, a multiwall sheet filled with a sound insulating material as described herein can provide a 110% improvement in the specific STL compared to the same material composition and structure multiwall sheet but without the sound insulating material, an almost 800% improvement as compared to the same material composition and thickness solid sheet, and an almost 5,200% improvement as compared to a solid steel sheet. A sound transmission loss of 42 dB is significant for a 1.7 kg/m² sheet of polycarbonate material. Such a sheet as disclosed herein can provide an overall best performance and low cost product for sound insulation. The lightweight multiwall sheet is easy to install and can be filled with the sound insulating material on site. The disclosed multiwall sheets comprising a sound insulating material can achieve a 100% to 500% improvement in specific STL performance. The multiwall sheets disclosed herein can be used in a variety of applications, including, but not limited to, industrial roof and sidewalls, commercial greenhouses, sunroom, swimming pool, and conservatory roofing, shopping center roofing, railway/metro stations, football stadium roofing, and roof lights.

In one embodiment, a multiwall sheet comprises: plastic walls, wherein the walls comprise a first wall; a second wall; and a transverse wall, wherein the first wall, the second wall, and the transverse wall extend longitudinally; a rib extending between adjacent walls; and a sound insulating material disposed in an area between two adjacent walls; wherein the sound insulating material has a velocity of sound greater than the velocity of sound of the plastic walls.

In another embodiment, a multiwall sheet comprises: plastic walls, wherein the walls comprise a first wall; a second wall; and a transverse wall, wherein the first wall, the second wall, and the transverse wall extend longitudinally; a rib extending between adjacent walls; and a sound insulating material disposed in an area between two adjacent walls; wherein the sound insulating material has an acoustic impedance of greater than or equal to 5 MRayl.

In one embodiment, a multiwall sheet comprises: polycarbonate walls, wherein the walls comprise: a first wall; a second wall; and a transverse wall, wherein the first wall, the second wall, and the transverse wall extend longitudinally; a rib extending between adjacent walls; and a sound insulating material disposed in an area between two adjacent walls; wherein the sound insulating material comprises silica and wherein the sound insulating material has a velocity of sound of greater than or equal to 4,000 m/s and an acoustic impedance of greater than or equal to 10 MRayl.

In one embodiment, a method of making a filled multiwall sheet, comprises: filling a multiwall sheet with a sound insulating material, wherein the multiwall sheet comprises: plastic walls, wherein the walls comprise: a first wall; a second wall; and a transverse wall, wherein the first wall, the second wall, and the transverse wall extend longitudinally; and a rib extending between adjacent walls; wherein the sound insulating material is disposed in an area between two adjacent walls and has a velocity of sound greater than the velocity of sound of the plastic walls.

In another embodiment, a method of making a multiwall sheet comprises: forming a multiwall sheet, wherein the multiwall sheet comprises plastic walls, wherein the plastic walls comprise: a first wall; a second wall; and a transverse wall, wherein the first wall, the second wall, and the transverse wall extend longitudinally; and a rib extending between adjacent walls; filling an area between two adjacent walls with a sound insulating material having a velocity of sound greater than the velocity of sound of the plastic walls.

In the various embodiments: (i) the multiwall sheet has an increase in the sound reduction index of greater than or equal to 50%, compared to a multiwall sheet having the same material composition and structure but without the sound insulating material; and/or (ii) the sound insulating material comprises silica; and/or (iii) the plastic walls comprise polycarbonate; and/or (iv) the multiwall sheet further comprises a clip located on an end of the multiwall sheet and/or (v) the multiwall sheet has a specific sound reduction index of greater than or equal to 15 decibels·m²/kg; and/or (vi) the multiwall sheet further comprises a cavity formed by a zone between two adjacent ribs in the area, wherein the sound insulating material is disposed in the cavity; and/or (vii) the cavity is greater than or equal to 50 vol. % filled with the sound insulating material; and/or (viii) the multiwall sheet further comprises an element disposed in the area, wherein the element is selected from the group consisting of light guides, light emitting diodes, fiber optics, motion sensors, phosphorescent filler, infrared material, reflective material, and combinations comprising at least one of the foregoing; and/or (ix) the multiwall sheet has an acoustic impedance greater than or equal to 5 MRayl; (x) the multiwall sheet has an acoustic impedance greater than or equal to 10 MRayl; and/or the multiwall sheet has an acoustic impedance greater than or equal to 14 MRayl; and/or (xi) determining a degree of sound insulating desired in an area of the structure and filling the multiwall sheet based upon the result.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to determine one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A multiwall sheet, comprising:
plastic walls, wherein the walls comprise:
a first wall;
a second wall; and
a transverse wall, wherein the first wall, the second wall, and the transverse wall extend longitudinally;
a rib extending between adjacent walls; and
a sound insulating material disposed in an area between two adjacent walls;
wherein the sound insulating material has a velocity of sound greater than the velocity of sound of the plastic walls.

2. The multiwall sheet of claim 1, wherein the multiwall sheet has an increase in the sound reduction index of greater than or equal to 50%, compared to a multiwall sheet having the same material composition and structure but without the sound insulating material.

3. The multiwall sheet of claim 1, wherein the sound insulating material comprises silica.

4. The multiwall sheet of claim 1, wherein the plastic walls comprise polycarbonate.

5. The multiwall sheet of claim 1, further comprising a clip located on an end of the multiwall sheet.

6. The multiwall sheet of claim 1, wherein the multiwall sheet has a specific sound reduction index of greater than or equal to 15 decibels·m²/kg.

7. The multiwall sheet of claim 1, further comprising a cavity formed by a zone between two adjacent ribs in the area, wherein the sound insulating material is disposed in the cavity.

8. The multiwall sheet of claim 7, wherein the cavity is greater than or equal to 50 vol. % filled with the sound insulating material.

9. The multiwall sheet of claim 1, further comprising an element disposed in the area, wherein the element is selected from the group consisting of light guides, light emitting diodes, fiber optics, motion sensors, phosphorescent filler, infrared material, reflective material, and combinations comprising at least one of the foregoing.

10. A multiwall sheet, comprising:
plastic walls, wherein the walls comprise:
a first wall;
a second wall; and
a transverse wall, wherein the first wall, the second wall, and the transverse wall extend longitudinally;
a rib extending between adjacent walls; and
a sound insulating material disposed in an area between two adjacent walls;
wherein the sound insulating material has an acoustic impedance of greater than or equal to 5 MRayl.

11. The multiwall sheet of claim 10, wherein the acoustic impedance is greater than or equal to 10 MRayl.

12. The multiwall sheet of claim 11, wherein the acoustic impedance is greater than or equal to 14 MRayl.

13. The multiwall sheet of claim 10, wherein the walls comprise polycarbonate.

14. The multiwall sheet of claim 10, wherein the sound insulating material comprises silica.

15. A multiwall sheet, comprising:
polycarbonate walls, wherein the walls comprise:
a first wall;
a second wall; and
a transverse wall, wherein the first wall, the second wall, and the transverse wall extend longitudinally;
a rib extending between adjacent walls; and
a sound insulating material disposed in an area between two adjacent walls;
wherein the sound insulating material comprises silica and wherein the sound insulating material has a velocity of sound of greater than or equal to 4,000 m/s and an acoustic impedance of greater than or equal to 10 MRayl.

16. The multiwall sheet of claim 15, further comprising an element disposed in the area, wherein the element is selected from the group consisting of light guides, light emitting diodes, fiber optics, motion sensors, phosphorescent filler, infrared material, reflective material, and combinations comprising at least one of the foregoing.

17. A method of sound insulating a structure, comprising:
filling a multiwall sheet with a sound insulating material, wherein the multiwall sheet comprises:
plastic walls, wherein the walls comprise:
a first wall;
a second wall; and
a transverse wall, wherein the first wall, the second wall, and the transverse wall extend longitudinally; and
a rib extending between adjacent walls;
wherein the sound insulating material is disposed in an area between two adjacent walls and has a velocity of sound greater than the velocity of sound of the plastic walls; and
attaching the multiwall sheet to the structure.

18. The method of claim 17, further comprising determining a degree of sound insulation desired in an area of the structure, and filling the multiwall sheet based upon the result.

19. The method of claim 17, wherein the sound insulating material has a velocity of sound of greater than or equal to 4,000 m/s and an acoustic impedance of greater than or equal to 10 MRayl.

20. The method of claim 17, wherein the multiwall sheet has a specific sound reduction index of greater than or equal to 15 decibels·m²/kg.
